(19) United States
(12) Patent Application Publication
(10) Pub. No.: US 2011/0149351 A1
(43) Pub. Date: Jun. 23, 2011

(54) IMAGE READING DEVICE, METHOD OF READING IMAGE, AND RECORDING MEDIUM STORING CONTROL PROGRAM FOR CONTROLLING IMAGE READING DEVICE

(75) Inventors: Katsuaki WAKUI, Toyokawa-shi (JP); Hideyuki Hashimoto, Toyokawa-shi (JP); Hidekazu Takahama, Nagoya-shi (JP); Hiroshi Murakami, Nagoya-shi (JP); Akira Ohhata, Toyokawa-shi (JP); Hiroyuki Suzuki, Toyokawa-shi (JP)

(73) Assignee: Konica Minolta Business Technologies, Inc., Tokyo (JP)

(21) Appl. No.: 12/962,285

(22) Filed: Dec. 7, 2010

(30) Foreign Application Priority Data
Dec. 18, 2009 (JP) 2009-287895

(51) Int. Cl. H04N 1/38

(52) U.S. Cl. 358/463

(57) ABSTRACT

An image reading device includes a transport unit for transporting a document, a scanner for scanning image data of the document transported by the transport unit, and a controller for controlling the image reading device. The controller extracts a plurality of one-character areas included in the image data, recognizes character data of each of the extracted one-character areas, determines presence or absence of line noise based on a result of recognition of each of the one-character areas, and displays presence of the line noise on an operation panel when it is determined that there is the line noise.

This application is based on Japanese Patent Application No. 2009-287895 filed with the Japan Patent Office on Dec. 18, 2009, the entire content of which is hereby incorporated by reference.

### BACKGROUND OF THE INVENTION

1. Field of the Invention

The present invention relates to an image reading device, and more particularly to an image reading device for detecting line noise generated in a read image due to dirt attached to a reading glass or the like, a method of reading an image, and a recording medium storing a control program for controlling the image reading device.

2. Description of the Related Art

When an image reading device reads an image with a commonly called document feeding method in which an image is read while a document is transported with a fixed reading position of an image sensor, dirt or the like attached to a reading glass or the like provided in the reading position causes occurrence of line noise along a feed direction (transport direction) of a sheet. Such occurrence of line noise results in lower image quality.

Japanese Laid-Open Patent Publication No. 09-238208 discloses a character recognition device. This device detects vertical line noise included in an image, and modifies a black pixel of a portion where the vertical line noise was detected to a white pixel, thereby removing the vertical line noise.

Japanese Laid-Open Patent Publication No. 07-021306 discloses a method of detecting dirt of an image sensor. This method detects presence or absence of a vertical component of a black pixel in a clear area of a sheet and its position information, compares the information detected by this reading with information detected by previous reading, determines that the image sensor has dirt if the vertical component of the black pixel is detected in the same position, and outputs an alarm.

According to the technique disclosed in Japanese Laid-Open Patent Publication No. 09-238208, however, a user cannot recognize that dirt or the like is attached to a reading glass or the like. Thus, once attached, the dirt remains attached. As a result, the character recognition device needs to keep performing a process for removing the line noise, resulting in lower process performance. Moreover, it is generally difficult to completely remove noise by image processing for removing noise, causing the noise which was not completely removed to remain or an image not including the noise to be removed as well. As such, lowering of image quality cannot fundamentally be prevented.

According to technique disclosed in Japanese Laid-Open Patent Publication No. 07-021306, a user can recognize presence of dirt because an alarm is given upon detection of dirt. However, the user cannot know a position of the dirt and thus cannot efficiently clean the dirt.

### SUMMARY OF THE INVENTION

The present invention was made to solve the problems as described above, and an object of the present invention is to provide an image reading device in which dirt resulting in line noise can readily be cleaned by a user, a method of reading an image, and a recording medium storing a control program for controlling the image reading device.

An image reading device according to an aspect of the present invention includes a transport unit for transporting a document, a scanner for scanning image data of the document transported by the transport unit, and a controller for controlling the image reading device. The controller extracts a plurality of one-character areas included in the image data, recognizes character data of each of the extracted one-character areas, determines presence or absence of line noise based on a result of recognition of each of the one-character areas, and displays presence of the line noise on an operation panel when it is determined that there is the line noise.

Preferably, the controller determines that there is the line noise when it is determined that there are at least a prescribed number of successive one-character areas where recognition failed in a transport direction of the document transported by the transport unit.

Preferably, the controller determines that there is the line noise when it is determined that there are at least a prescribed number of successive one-character areas having character data recognized as specific character data in a transport direction of the document transported by the transport unit.

Preferably, the controller determines that there is the line noise when it is determined that there are at least a prescribed number of successive one-character areas where recognition failed or one-character areas having character data recognized as specific character data in a transport direction of the document transported by the transport unit.

In particular, the controller adjusts a recognition level of the character data of each of the extracted one-character areas in accordance with an instruction, and adjusts a value of the prescribed number in accordance with the adjusted recognition level of the character data.

Preferably, the controller identifies and displays a position of the line noise in the image data on the operation panel.

A method of reading an image performed in an image reading device according to an aspect of the present invention includes the steps of transporting a document, scanning image data of the transported document, extracting a plurality of one-character areas included in the image data, recognizing character data of each of the extracted one-character areas, determining presence or absence of line noise based on a result of recognition of each of the one-character areas, and displaying presence of the line noise on an operation panel when it is determined that there is the line noise.

Preferably, in the step of determining presence or absence of line noise, it is determined that there is the line noise when it is determined that there are at least a prescribed number of successive one-character areas where recognition failed in a transport direction of the transported document.

Preferably, in the step of determining presence or absence of line noise, it is determined that there is the line noise when it is determined that there are at least a prescribed number of successive one-character areas having character data recognized as specific character data in a transport direction of the transported document.

Preferably, in the step of determining presence or absence of line noise, it is determined that there is the line noise when it is determined that there are at least a prescribed number of successive one-character areas where recognition failed or one-character areas having character data recognized as specific character data in a transport direction of the transported document.

In particular, the method further includes the steps of adjusting a recognition level of the character data of each of the extracted one-character areas in accordance with an instruction, and adjusting a value of the prescribed number in accordance with the adjusted recognition level of the character data.

Preferably, in the displaying step, a position of the line noise in the image data is identified and displayed on the operation panel.

Regarding recording medium storing a control program to be executed by a computer of an image reading device according to an aspect of the present invention, the control program causes the computer of the image reading device to perform a process including the steps of transporting a document, scanning image data of the transported document, extracting a plurality of one-character areas included in the image data, recognizing character data of each of the extracted one-character areas, determining presence or absence of line noise based on a result of recognition of each of the one-character areas, and displaying presence of the line noise on an operation panel when it is determined that there is the line noise.

Preferably, in the step of determining presence or absence of line noise, it is determined that there is the line noise when it is determined that there are at least a prescribed number of successive one-character areas where recognition failed in a transport direction of the transported document.

Preferably, in the step of determining presence or absence of line noise, it is determined that there is the line noise when it is determined that there are at least a prescribed number of successive one-character areas having character data recognized as specific character data in a transport direction of the transported document.

Preferably, in the step of determining presence or absence of line noise, it is determined that there is the line noise when it is determined that there are at least a prescribed number of successive one-character areas where recognition failed or one-character areas having character data recognized as specific character data in a transport direction of the transported document.

In particular, the control program causes the computer of the image reading device to perform a process further including the steps of adjusting a recognition level of the character data of each of the extracted one-character areas in accordance with an instruction, and adjusting a value of the prescribed number in accordance with the adjusted recognition level of the character data.

Preferably, in the displaying step, a position of the line noise in the image data is identified and displayed on the operation panel.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an external view of an MFP as an image reading device according to an embodiment of the present invention.

FIG. 2 illustrates a hardware configuration of the MFP according to the embodiment of the present invention.

FIG. 3 illustrates functional blocks regarding a process of detecting line noise.

FIGS. 4A and 4B illustrate an example of a result of extraction of a one-character area by a character cutting unit.

FIG. 5 illustrates another example of a result of extraction of a one-character area by the character cutting unit.

FIG. 6 illustrates a result of determination by a character recognition unit when line noise has occurred.

FIG. 7 illustrates a process of determining whether or not dirt is attached to a reading glass, which is performed by a dirt determination unit.

FIG. 8 illustrates a process of outputting a result of the dirt determination process, which is performed by a determination result output unit.

FIG. 9 illustrates a screen displayed on an operation display.

FIG. 10 illustrates the dirt determination process according to a first variation of a first embodiment.

FIGS. 11A and 11B illustrate an example of a result of determination by the character recognition unit when line noise has occurred.

FIG. 12 illustrates the dirt determination process according to a second variation of the first embodiment.

FIGS. 13A and 13B illustrate another example of a result of determination by the character recognition unit when line noise has occurred.

FIG. 14 illustrates a setting screen for adjusting a level of character recognition.

### DESCRIPTION OF THE PREFERRED EMBODIMENTS

### First Embodiment

An embodiment of the present invention will be described hereinafter with reference to the drawings. In the following description, the same components and constituent elements have the same characters allotted, and their names and functions are also the same.

(Overall Structure of MFP)

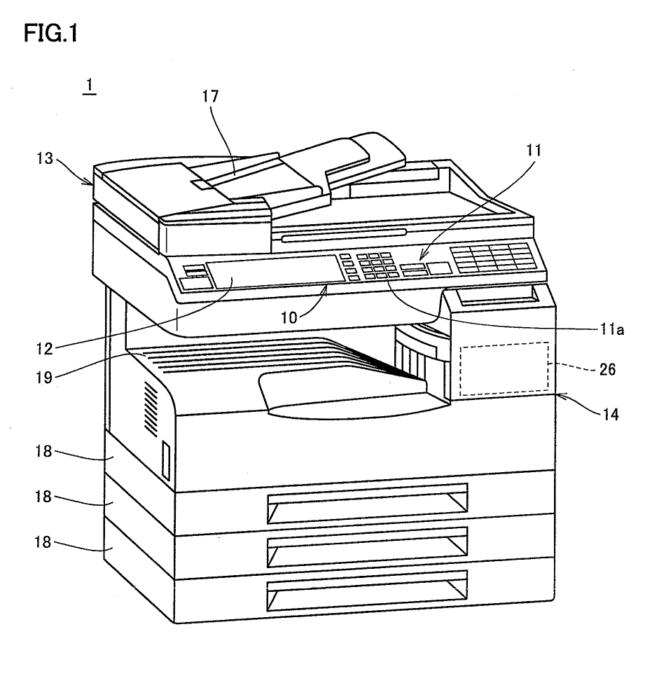

FIG. 1 is used to illustrate an external view of an MFP (Multi Function Peripheral) 1 as an image reading device according to an embodiment of the present invention.

Referring to FIG. 1, MFP 1 according to the embodiment of the present invention is a digital multifunction machine having a copy function, a scanner function, a facsimile function and the like.

MFP 1 includes an operation panel 10 to be described later. Operation panel 10 includes a plurality of keys 11a, an operation unit 11 for accepting input of various kinds of instructions, data such as characters and numbers resulting from operation of keys 11a by a user, and an operation display 12 made of a liquid crystal or the like for displaying an instruction menu to the user, information about an obtained image and the like.

MFP 1 also includes a scanner 13 for optically reading a document to obtain image data, and a printer 14 for printing an image on a recording sheet based on the image data.

MFP 1 further includes a feeder 17 on an upper surface of a body of MFP 1 for feeding a document to scanner 13, a sheet feed unit 18 at the bottom for supplying a recording sheet to printer 14, and a tray 19 in a central portion to which the recording sheet with an image printed by printer 14 is delivered.

In addition, MFP 1 includes therein a storage unit 26 and the like for storing required data such as a control program used in each unit for controlling the body, image data, and the like.

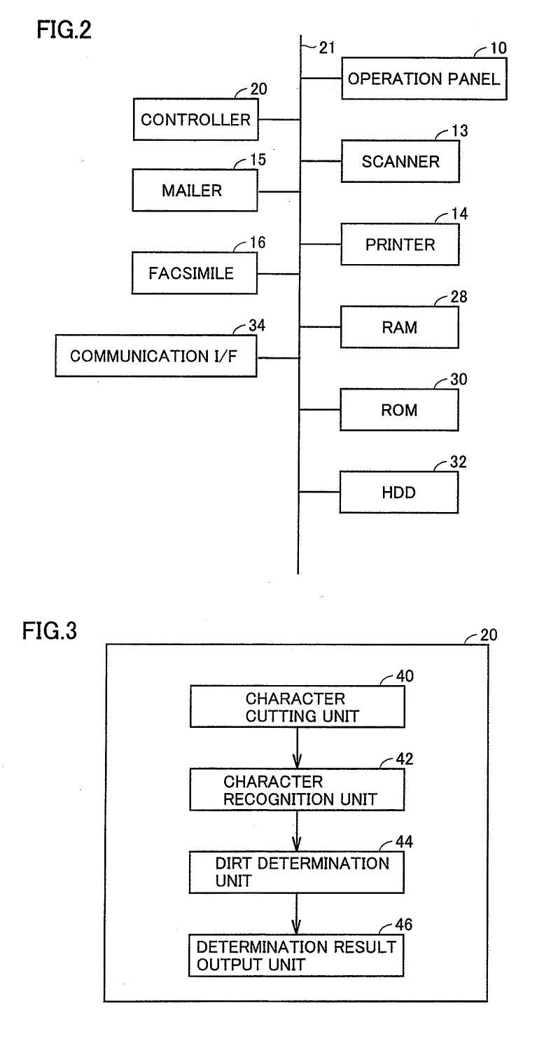

FIG. 2 is used to illustrate a hardware configuration of MFP 1 according to the embodiment of the present invention.

Referring to FIG. 2, MFP 1 according to the embodiment of the present invention includes scanner 13 for converting a document such as a paper medium into image data (electronic data), printer 14 for performing print processing, a mailer 15 for transmitting and receiving an electronic mail (also referred to as an E-mail), a facsimile 16 for sending data through public lines, a communication interface (I/F) 34, operation panel 10 for executing an operation instruction such as input, a ROM (Read Only Memory) 30 storing a control program and the like, a RAM (Random Access Memory) 28 used as a work area and the like where a controller 20 and the like perform control processing, an HDD (Hard Disk Drive) 32 storing various kinds of information and the like registered with MFP 1, and controller 20 for controlling MFP 1 as a whole. Controller 20 is formed of a CPU (Central Processing Unit) and the like, for example. ROM 30, RAM 28, and HDD 32 form storage unit 26.

Each unit is connected to controller 20 via an internal bus 21, and controller 20 can supply and receive data to and from each unit.

Scanner 13 includes an optical sensor formed of a plurality of photoelectric conversion elements (light receiving elements). A document placed on feeder 17 is transported to scanner 13. The optical sensor photoelectrically reads image information such as a photograph, a character, and a picture from the document through a reading glass, and obtains image data. The obtained image data is converted to digital data, and after being subjected to various kinds of well-known image processing, temporarily stored in RAM 28, and sent to printer 14 and the like for use in printing an image and storing data.

Printer 14 prints an image on a recording sheet stored in sheet feed unit 18, based on the image data obtained by scanner 13 and the like.

Mailer 15 transmits and receives an electronic mail to and from a mail server and the like which are connected to mailer 15 via a not-shown network.

Facsimile 16 transmits the image data obtained by scanner 13 and the like to another facsimile device according to a prescribed protocol.

Communication I/F 34 is an interface for connecting each unit in MFP 1 to external equipment and the like connected to the not-shown network. Communication I/F 34 is connected to the network by wired or wireless connection, and supplies and receives data to and from another MFP, PC (Personal Computer) or the like. Examples of the network include a LAN (Local Area Network) and a WAN (Wide Area Network).

Operation display 12 of operation panel 10 includes an LCD (Liquid Crystal Display) and a touch panel. The LCD displays various kinds of modes, and the touch panel accepts various kinds of settings and the like in accordance with displayed contents and the like. Operation unit 11 is used for various kinds of input by the user. These elements function as an essential part of a user interface.

MFP 1 according to the embodiment of the present invention can determine whether or not dirt is attached to a reading glass based on image data (also referred to as a read image) read by scanner 13, and when dirt is attached to the reading glass, notify the user of a position where the dirt is attached. MFP 1 can determine whether or not dirt is attached and notify the user of a position where the dirt is attached not only for a read image when a scanner function is utilized, but also for a read image when a copy function or a facsimile function is utilized.

By way of example, the following description refers to a case where a scan function of MFP 1 is utilized.

FIG. 3 is used to illustrate functional blocks regarding a process of detecting line noise. Referring to FIG. 3, the process of detecting line noise is performed by a character cutting unit 40, a character recognition unit 42, a dirt determination unit 44, and a determination result output unit 46. The functions of the blocks of character cutting unit 40, character recognition unit 42, dirt determination unit 44, and determination result output unit 46 are implemented when controller 20 reads and executes a program stored in ROM 30, for example.

Character cutting unit 40 performs a process of extracting a character area in image data obtained by scanner 13 and the like and stored in RAM 28 and the like. Character cutting unit 40 performs a process of cutting each character as an individual character area (a character area extracted as one character is hereinafter referred to also as a one-character area).

Character recognition unit 42 performs a character recognition process with a known character recognition method (such as pattern matching) for each one-character area extracted by character cutting unit 40. Then, character recognition unit 42 determines whether or not character recognition was successfully carried out for each one-character area. In this example, successful character recognition means that a character corresponding to a one-character area could be identified by pattern matching or the like, and unsuccessful (i.e., failed) character recognition means that a character corresponding to a one-character area could not be identified by pattern matching or the like.

Dirt determination unit 44 determines whether or not dirt is attached to the reading glass based on a result of determination by character recognition unit 42.

If it is determined that dirt is attached to the reading glass, determination result output unit 46 outputs a result to that effect.

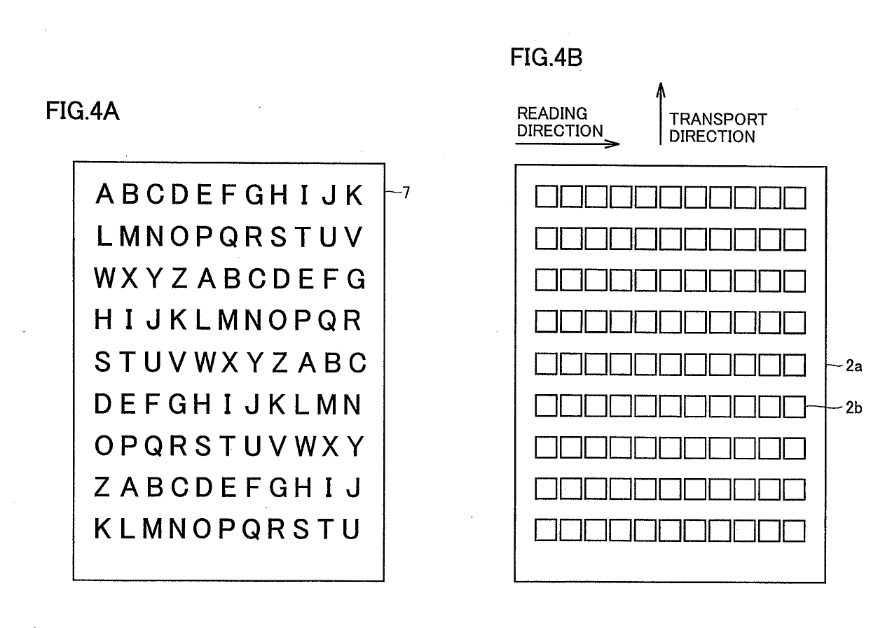

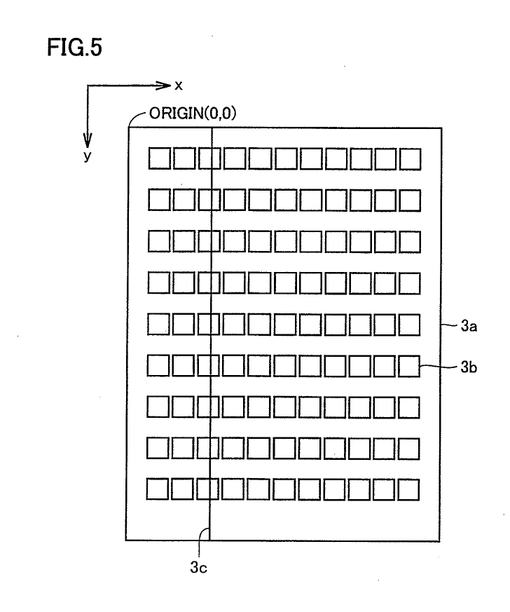

FIGS. 4A and 4B are used to illustrate an example of a result of extraction of a one-character area by character cutting unit 40.

Referring to FIG. 4A, a document 7 is shown in this example. In this example, alphabetical characters of “ABCDEFGHIJKLMNOPQRSTUVWXYZ . . . ” are written on document 7.

Referring to FIG. 4B, a one-character area 2b extracted by character cutting unit 40 in image data 2a of document 7 obtained by scanner 13 and the like is shown. In the image data shown, dirt is not attached to the reading glass and line noise has not occurred as a result of extraction of the one-character areas by character cutting unit 40. A direction perpendicular to a reading direction shown in FIG. 4B is indicated as a transport direction of the document.

FIG. 5 is used to illustrate another example of a result of extraction of a one-character area by character cutting unit 40.

Referring to FIG. 5, image data 3a is shown where dirt is attached to the reading glass and line noise has occurred as a result of extraction of a one-character area by character cutting unit 40. When dirt is attached to the reading glass, line noise occurs in the transport direction.

Referring back to FIG. 4B, when line noise has not occurred, character recognition is successfully carried out for all one-character areas in the character recognition process performed by character recognition unit 42.

On the other hand, when line noise has occurred as shown in FIG. 5, character recognition fails for one-character areas including the line noise in the character recognition process performed by character recognition unit 42.

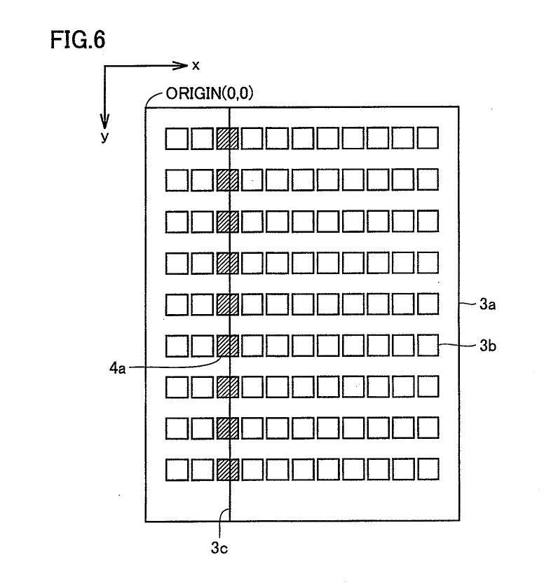

FIG. 6 is used to illustrate a result of determination by character recognition unit 42 when line noise has occurred. Here, one-character areas with failed character recognition are indicated by hatched lines. Character recognition failed for the one-character areas including the line noise.

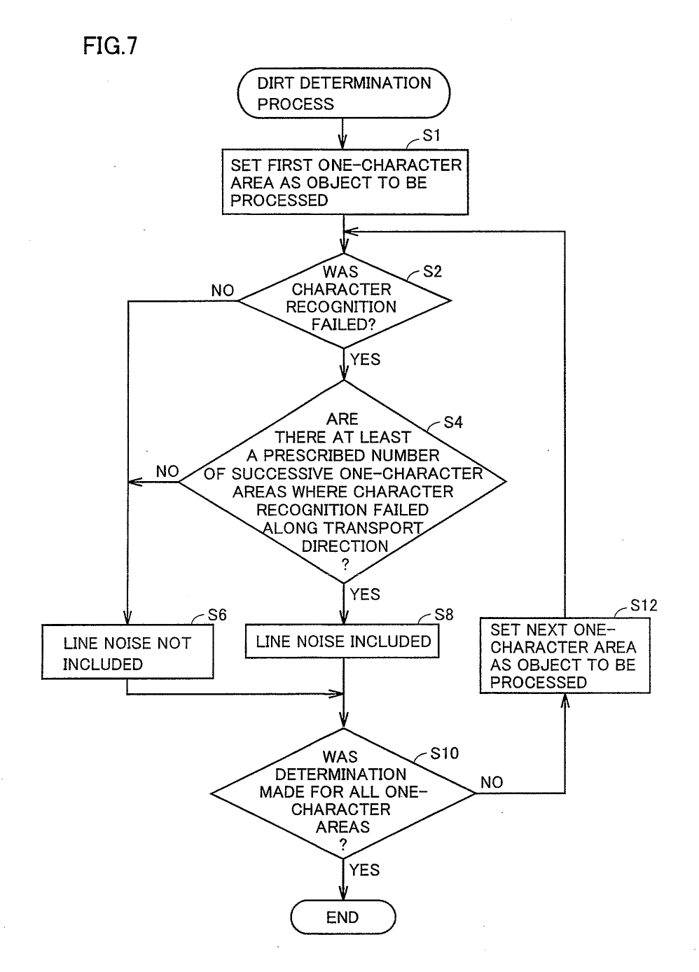

FIG. 7 is used to illustrate a process of determining whether or not dirt is attached to the reading glass (hereinafter referred to also as a dirt determination process), which is performed by dirt determination unit 44. This dirt determination process is implemented when controller 20 reads and executes a program stored in ROM 30.

In the dirt determination process, it is determined whether or not the character recognition was successfully carried out for all one-character areas extracted by character cutting unit 40, and determination of whether or not dirt is attached is made based on whether or not the character recognition failed successively for at least a prescribed number of one-character areas in the transport direction from a one-character area where the character recognition failed.

Referring to FIG. 7, first, a first one-character area included in image data is set as an object to be processed (step S1).

Next, it is determined whether or not the character recognition failed for the one-character area as the object to be processed (step S2). If it is determined that the character recognition did not fail (NO at step S2), it is determined that the one-character area as the object to be processed does not include line noise (step S6). Then, the process proceeds to step S10.

On the other hand, if it is determined that the character recognition failed (YES at step S2), it is determined whether or not there are at least a prescribed number of successive one-character areas where the character recognition failed in the transport direction from the one-character area as the object to be processed (step S4).

If it is determined at step S4 that there are at least the prescribed number of successive one-character areas where the character recognition failed in the transport direction (YES at step S4), it is determined that the one-character area as the object to be processed includes line noise (step S8). Then, the process proceeds to step S10.

On the other hand, if it is determined at step S4 that there are not at least the prescribed number of successive one-character areas where the character recognition failed in the transport direction (NO at step S4), it is determined that the one-character area as the object to be processed does not include line noise (step S6). Then, the process proceeds to step S10.

At step S10, it is determined whether or not all one-character areas included in the image data have been processed, namely, whether or not determination has been made for all one-character areas. If determination has not been made for all one-character areas included in the image data (NO at step S10), the next one-character area is set as an object to be processed (step S12).

Then, the process returns to step S2. Subsequently, the process from steps S2 to S12 is repeated until determination is made for all one-character areas, and upon completion of determination for all one-character areas (YES at step S10), the process ends.

The process from steps S4 to S8 of determining whether or not a one-character area as an object to be processed includes line noise can also be interpreted as a process of determining whether or not dirt is attached to the reading glass. This is because if there is a one-character area including line noise, it is highly likely that dirt resulting in line noise is attached to the reading glass.

In this manner, dirt determination unit 44 determines that dirt is attached to the reading glass if there are at least the prescribed number of successive one-character areas where the character recognition failed, and determines that dirt is not attached to the reading glass if there are not at least the prescribed number of successive one-character areas where the character recognition failed. In the flowchart of the dirt determination process of FIG. 7, each of the one-character areas is successively set as an object to be processed, it is determined whether or not the character recognition failed for the one-character area as the object to be processed, and if it is determined that the character recognition failed for the one-character area as the object to be processed, it is determined whether or not the character recognition failed successively for at least the prescribed number of one-character areas. This method is not particularly restrictive, as long as it can be determined whether or not the character recognition failed successively for at least the prescribed number of one-character areas.

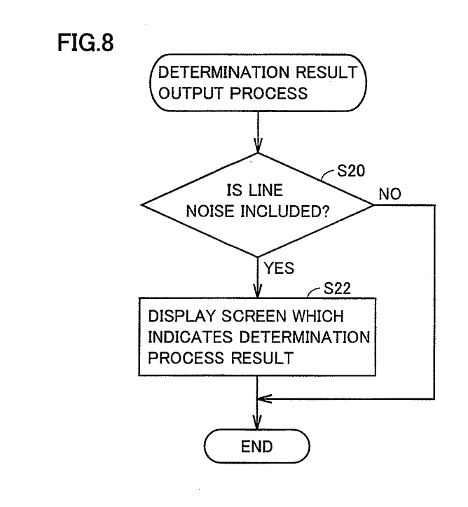

FIG. 8 is used to illustrate a process of outputting a result of the dirt determination process (determination result output process), which is performed by determination result output unit 46. This determination result output process is implemented when controller 20 reads and executes a program stored in ROM 30.

In the determination result output process, a screen for indicating a determination result is displayed based on a result of the dirt determination process by dirt determination unit 44, namely, presence or absence of attached dirt.

Referring to FIG. 8, determination is made of whether or not it was determined that line noise was included, namely, dirt was attached to the reading glass, based on the result of the dirt determination process by dirt determination unit 44 (step S20).

If determination is made that it was determined that dirt was attached to the reading glass by dirt determination unit 44 (YES at step S20), the screen for indicating the determination result is displayed on operation display 12 (step S22).

On the other hand, if determination is made that it was determined that dirt was not attached to the reading glass by dirt determination unit 44 (NO at step S20), the determination result is not indicated and the process ends.

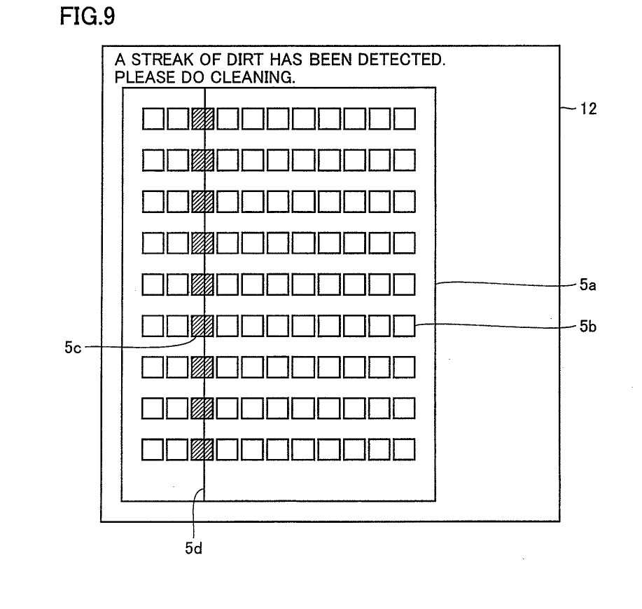

FIG. 9 is used to illustrate the screen displayed on operation display 12 at step S22 in the flowchart of the determination result output process shown in FIG. 8.

Referring to FIG. 9, operation display 12 displays a message that prompts the user to clean the reading glass (“A streak of dirt has been detected. Please do cleaning.”), and reduced image data 5a, which is reduced image data including line noise 5d read by scanner 13.

Here, a one-character area determined as including the line noise in the flowchart of the dirt determination process shown in FIG. 7 is displayed in a manner distinguishable from a one-character area determined as not including the line noise.

In this example, the one-character area determined as including the line noise is indicated by hatched lines. Although the one-character area determined as including the line noise is indicated by hatched lines in this example, such indication is not particularly restrictive. The one-character area determined as including the line noise may be indicated in any form as long as being distinguishable from the other areas. For example, the area may be flashed, or an object that indicates a position of the area by animation may be displayed. The display of the message of “A streak of dirt has been detected. Please do cleaning.” may be replaced by audio output to that effect.

In this example where there is one line noise, the reduced image data of that image data is displayed with the one-character area determined as including the line noise being indicated by hatched lines. Alternatively, if there are a plurality of (e.g., two) line noise, a one-character area determined as including the plurality of line noise is likewise indicated by hatched lines.

Accordingly, the user can readily see that dirt is attached to the reading glass by looking at the image data displayed on operation display 12 shown in FIG. 9. The user can also readily identify a position of the attachment. Therefore, the dirt attached to the reading glass can efficiently be cleaned, thereby fundamentally preventing occurrence of line noise.

Although the above example has been described with reference to a case where a scan function of MFP 1 is utilized, the present invention is likewise applicable to a case where another function such as a copy function or a facsimile function is utilized.

That is, when a copy process is performed by placing a document on feeder 17 and reading an image with a commonly called document feeding method by utilizing a copy function, or when facsimile transmission is made by placing a document on feeder 17 and reading an image with the commonly called document feeding method by utilizing a facsimile function, dirt or the like attached to a reading glass or the like provided in a reading position results in occurrence of line noise along a feed direction (transport direction) of a sheet, as in the case where a scan function is utilized. To prevent such occurrence, by reading an image and performing the process of detecting line noise as described above prior to the copy process or facsimile transmission, dirt attached to the reading glass can readily be identified, as in the case where a scan function is utilized. This allows efficient cleaning of the dirt attached to the reading glass, thereby fundamentally preventing occurrence of line noise.

### First Variation of First Embodiment

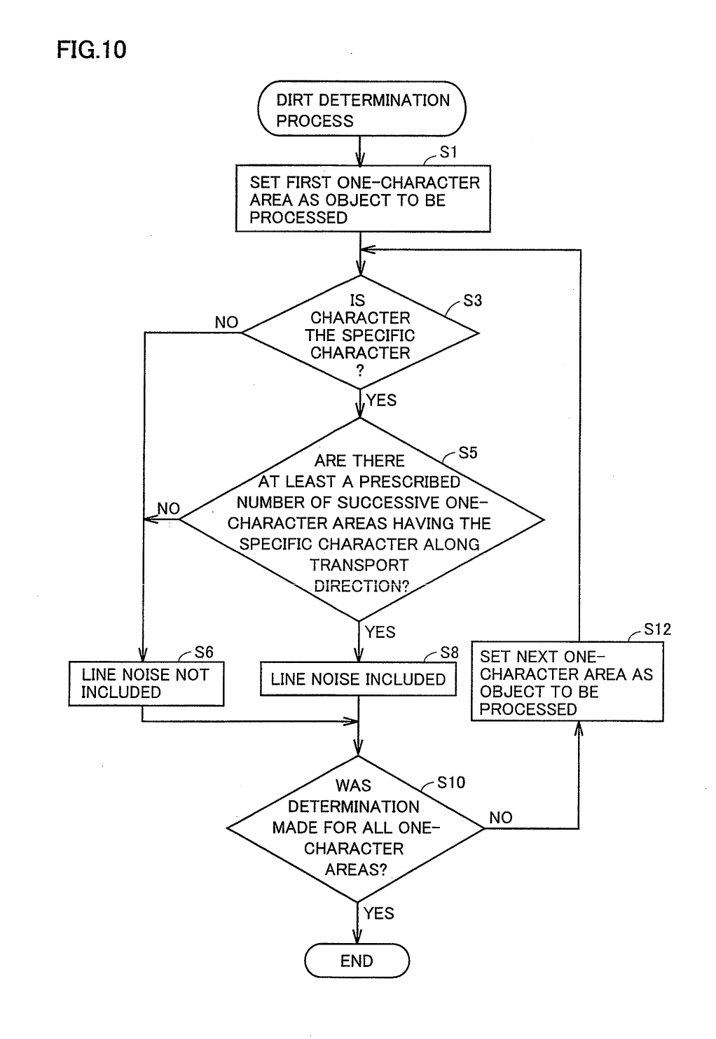

FIG. 10 is used to illustrate the dirt determination process according to a first variation of the first embodiment described above.

Referring to FIG. 10, the dirt determination process according to the first variation of the first embodiment is different from the dirt determination process shown in FIG. 7 according to the first embodiment described above in that step S2 in the flowchart has been replaced with step S3, and that step S4 has been replaced with step S5. The process is otherwise the same, and thus detailed description thereof will not be repeated. This dirt determination process is implemented when controller 20 reads and executes a program stored in ROM 30.

In the dirt determination process according to the first variation of the first embodiment, it is determined whether or not a character of a one-character area as an object to be processed is a specific character for all one-character areas extracted by character cutting unit 40, and if it is determined that the character is the specific character, determination of whether or not dirt is attached is made based on whether or not there are at least a prescribed number of successive one-character areas having the specific character recognized by the character recognition process in the transport direction from the one-character area as the object to be processed.

First, a first one-character area included in the image data is set as an object to be processed (step S1). Next, it is determined whether or not a character recognized by the character recognition process is a specific character for the one-character area as the object to be processed (step S3).

The specific character refers to a character similar in shape to line noise, such as the Arabic numeral “1”, the letter “l” of the alphabet, a hyphen “-”, or the like.

If it is determined at step S3 that the character of the one-character area as the object to be processed is not the specific character as a result of recognition (NO at step S3), it is determined that the one-character area as the object to be processed does not include line noise (step S6). Then, the process proceeds to step S10.

On the other hand, if it is determined at step S3 that the character of the one-character area as the object to be processed, which is recognized by the character recognition process, is the specific character (YES at step S3), it is determined whether or not there are at least a prescribed number of successive one-character areas having the specific character as a result of character recognition in the transport direction from the one-character area as the object to be processed (step S5).

If it is determined at step S5 that there are at least the prescribed number of successive one-character areas having the specific character as a result of character recognition along the transport direction (YES at step S5), it is determined that the one-character area as the object to be processed includes line noise (step S8). Then, the process proceeds to step S10.

If it is determined at step S5 that there are not at least the prescribed number of successive one-character areas having the specific character as a result of character recognition along the transport direction (NO at step S5), it is determined that the one-character area as the object to be processed does not include line noise (step S6). Then, the process proceeds to step S10.

At step S10, it is determined whether or not all one-character areas included in the image data have been processed, namely, whether or not determination has been made for all one-character areas. If determination has not been made for all one-character areas (NO at step S10), the next one-character area is set as an object to be processed (step S12). Then, the process returns to step S3. The process from steps S3 to S12 is repeated until determination is made for all one-character areas, and upon completion of determination for all one-character areas (YES at step S10), the process ends.

In the first embodiment, character recognition unit 42 performs the character recognition process with a known character recognition method (such as pattern matching) for the area of character data, and determines that a one-character area where the character recognition failed may include line noise. Alternatively, an area including line noise may be determined as having a specific character.

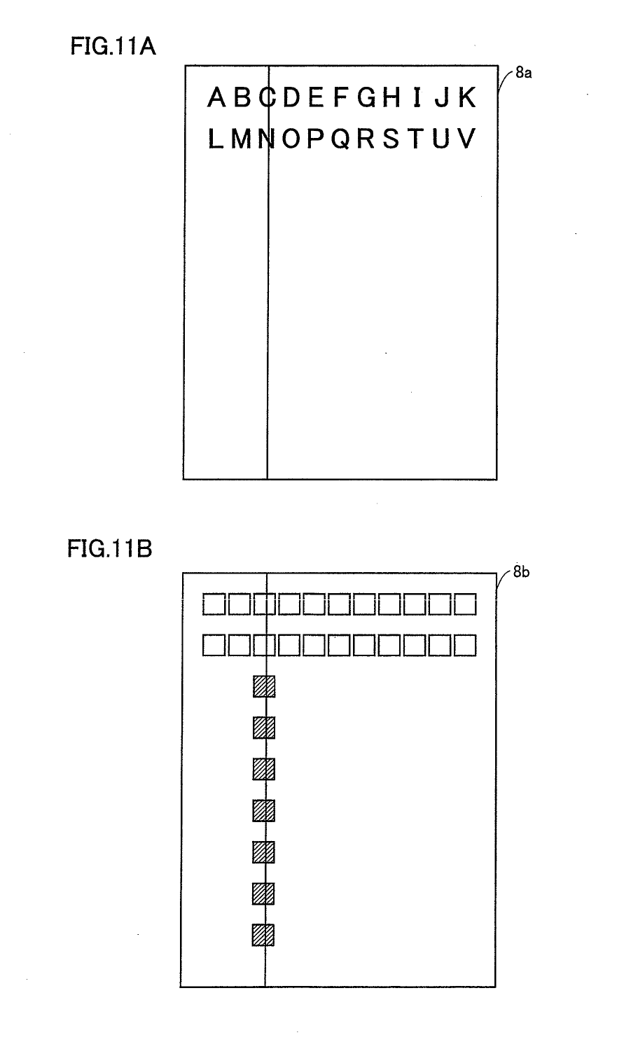

FIGS. 11A and 11B are used to illustrate an example of a result of determination by character recognition unit 42 when line noise has occurred.

Referring to FIG. 11A, this example shows a case where line noise has occurred in image data 8a. In this example, the line noise has occurred in an area with characters, as well as in a blank area originally without characters.

In this case, namely, in a case where line noise has occurred in a blank area, part of the line noise is similar in shape to the Arabic numeral “1”, for example, and may be determined as the Arabic numeral “1”.

FIG. 11B illustrates image data 8b which shows a result of determination by character recognition unit 42 for image data 8a. In this example where the line noise has occurred in the blank area, part of the line noise is determined as a specific character (e.g., the Arabic numeral “1”) in a one-character area indicated by hatched lines.

As described above, in the dirt determination process according to the first variation of the first embodiment, if a one-character area as an object to be processed has a specific character, it is determined whether or not there are at least a prescribed number of successive one-character areas having the specific character as a result of character recognition in the transport direction from the one-character area as the object to be processed. That is, if there are at least the prescribed number of successive one-character areas having a character similar in shape to part of the line noise such as the Arabic numeral “1”, it is determined that line noise is included. Namely, it is determined that dirt is attached to the reading glass.

With this process, even if line noise has occurred in a blank area originally without characters as shown in FIG. 11A, for example, the line noise can be appropriately detected. Accordingly, detection accuracy of attached dirt to the reading glass can be increased, which allows the user to readily clean the dirt which causes the line noise.

### Second Variation of First Embodiment

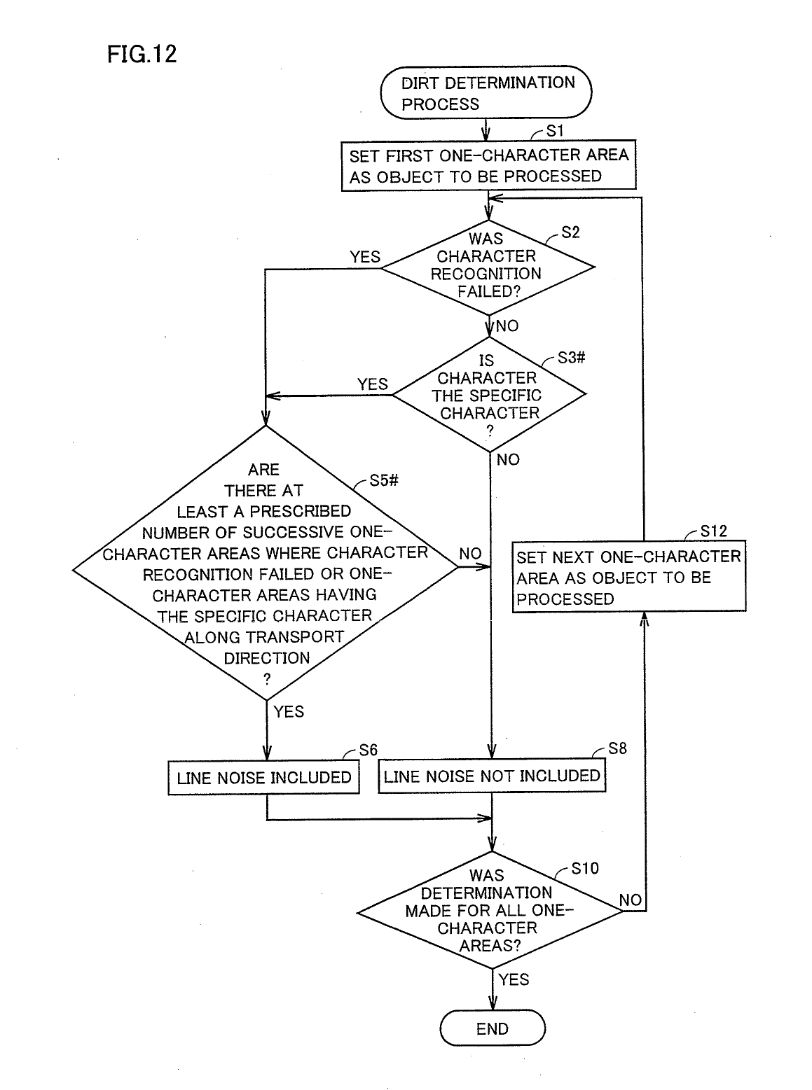

FIG. 12 is used to illustrate the dirt determination process according to a second variation of the first embodiment described above.

Referring to FIG. 12, the dirt determination process according to the second variation of the first embodiment is different from the dirt determination process shown in FIG. 7 according to the first embodiment described above in that step S4 in the flowchart has been replaced with step S3#, and that step S5# has been added. The process is otherwise the same, and thus detailed description thereof will not be repeated. This dirt determination process is implemented when controller 20 reads and executes a program stored in ROM 30.

In the dirt determination process according to the second variation of the first embodiment, it is determined whether or not character recognition was successfully carried out for all one-character areas extracted by character cutting unit 40, and determination of whether or not dirt is attached is made based on whether or not there are at least a prescribed number of successive one-character areas where the character recognition failed or one-character areas having a specific character in the transport direction from a one-character area where the character recognition failed.

First, a first one-character area included in the image data is set as an object to be processed (step S1). Next, it is determined whether or not character recognition failed in the character recognition process for the one-character area as the object to be processed (step S2). If it is determined at step S2 that the character recognition did not fail (NO at step S2), it is determined whether or not a character recognized by the character recognition is a specific character (step S3#).

As described above, the specific character refers to a character similar in shape to line noise, such as the Arabic numeral “1”, the letter “l” of the alphabet, a hyphen “-”, or the like.

If it is determined at step S3# that the character of the one-character area as the object to be processed is not the specific character as a result of recognition (NO at step S3#), it is determined that the one-character area as the object to be processed does not include line noise (step S8). Then, the process proceeds to step S10.

On the other hand, if the character recognition failed for the one-character area as the object to be processed (YES at step S2), or if the character of the one-character area as the object to be processed is recognized as the specific character (YES at step S3#), it is determined whether or not there are at least a prescribed number of successive one-character areas where the character recognition failed or one-character areas having the specific character in the transport direction from the one-character area as the object to be processed (step S5#).

If it is determined at step S5# that there are at least the prescribed number of successive one-character areas where the character recognition failed or one-character areas having the specific character along the transport direction (YES at step S5#), it is determined that the one-character area as the object to be processed includes line noise (step S6). Then, the process proceeds to step S10.

If it is determined at step S5# that there are not at least the prescribed number of successive one-character areas where the character recognition failed or one-character areas having the specific character along the transport direction (NO at step S5#), it is determined that the one-character area as the object to be processed does not include line noise (step S8). Then, the process proceeds to step S10.

At step S10, it is determined whether or not all one-character areas included in the image data have been processed, namely, whether or not determination has been made for all one-character areas. If determination has not been made for all one-character areas (NO at step S10), the next one-character area is set as an object to be processed (step S12). Then, the process returns to step S2. The process from steps S2 to S12 is repeated until determination is made for all one-character areas, and upon completion of determination for all one-character areas (YES at step S10), the process ends.

In the dirt determination process according to the second variation of the first embodiment, dirt determination unit 44 determines that dirt is attached to the reading glass if there are at least the prescribed number of successive one-character areas where the character recognition failed or one-character areas having the character recognized as the specific character.

Accordingly, even if image data includes both an area with characters and a blank area without characters, with line noise occurring in both areas, the line noise in both areas can be detected.

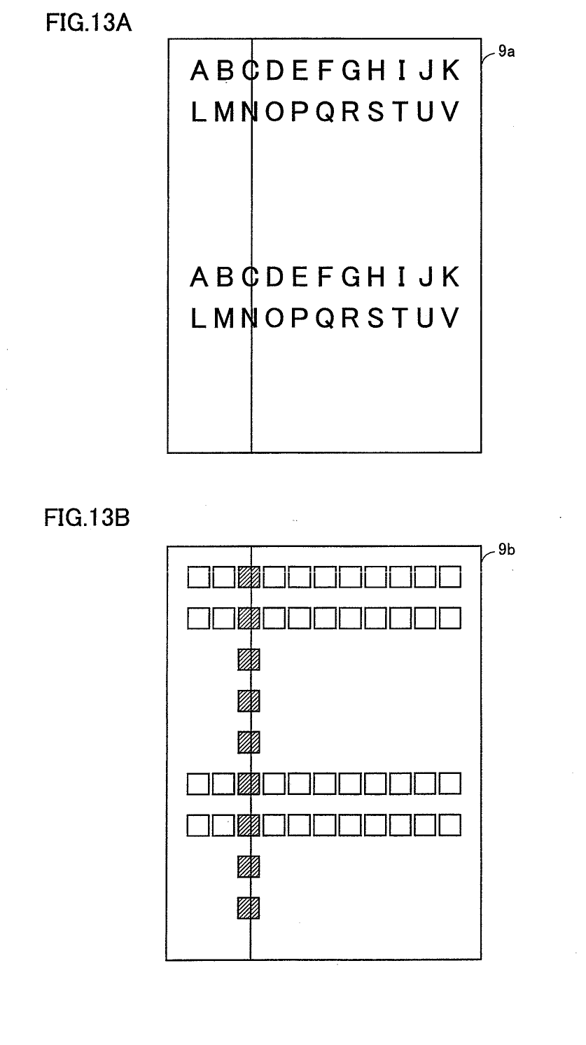

FIGS. 13A and 13B are used to illustrate another example of a result of determination by character recognition unit 42 when line noise has occurred.

Referring to FIG. 13A, this example shows a case where line noise has occurred in image data 9a. Image data 9a includes both an area with characters and a blank area originally without characters, and line noise has occurred in both areas.

FIG. 13B illustrates image data 9b which shows a result of determination by character recognition unit 42 for image data 9a. In this example, at least a prescribed number of successive one-character areas where character recognition failed or one-character areas having a character recognized as a specific character are indicated with hatched lines.

As described above, in the dirt determination process according to the second variation of the first embodiment, if character recognition failed for a one-character area as an object to be processed, or if it is determined that a one-character area as an object to be processed has a specific character, it is determined whether or not there are at least a prescribed number of successive one-character areas where the character recognition failed or one-character areas having the specific character in the transport direction from the one-character area as the object to be processed. That is, if there are at least the prescribed number of successive one-character areas where the character recognition failed or one-character areas having the specific character similar in shape to part of the line noise such as the Arabic numeral “1”, it is determined that line noise is included. Namely, it is determined that dirt is attached to the reading glass.

With this process, as shown in FIG. 13B, determination that the line noise has occurred only in the blank area without characters is not made, but occurrence of the line noise in the area with characters can also be appropriately detected. Accordingly, detection accuracy of attached dirt to the reading glass can be increased, which allows the user to readily clean the dirt which causes the line noise.

### Second Embodiment

The first embodiment has been described with reference to a method of detecting line noise in a read image caused by dirt attached to a reading glass, when a scan function of MFP 1 is utilized.

MFP 1 has the functions other than the scan function, as described above. For example, MFP 1 has a function of sending image data obtained by a scanner as attached file data by e-mail by using a scan function and a mail function associated with each other (also referred to simply as Scan-to-E-mail). For example, by performing a character recognition process on image data obtained by a scanner and sending file data after the character recognition process by e-mail when performing the Scan-to-E-mail, a user who receives the file data by the e-mail transmission can retrieve a character included in the file data, or copy the text data, for example.

Accordingly, for example, a setting screen is provided which is capable of adjusting a level of character recognition during the character recognition process (e.g., a threshold value of matching such as pattern matching) in accordance with quality, contents and the like of image data obtained by the scanner when the Scan-to-E-mail is performed.

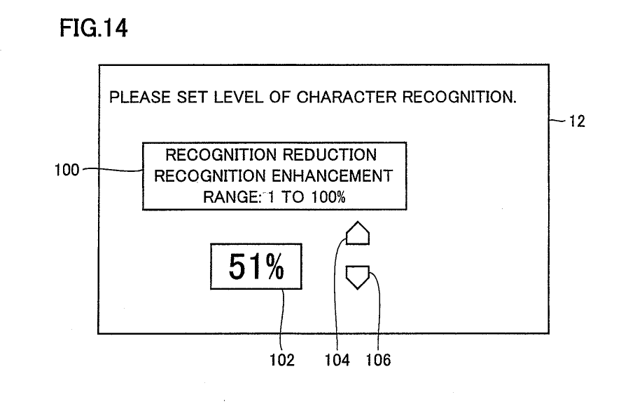

FIG. 14 is used to illustrate the setting screen for adjusting the level of character recognition.

Referring to FIG. 14, a setting screen for adjusting a level of character recognition is displayed on operation display 12.

In MFP 1 according to a second embodiment of the present invention, the level of character recognition can be adjusted by executing a prescribed operation instruction on operation panel 10. Specifically, when the prescribed operation instruction is executed, controller 20 displays the setting screen on operation display 12 of operation panel 10. A software program for displaying this setting screen is stored in ROM 30, for example.

Here, the setting screen displays a message of “Please set the level of character recognition.” and a display object 100. Specifically, the setting screen displays “Range of recognition reduction and recognition enhancement: 1 to 100%,” and an operator can understand that the level of character recognition can be adjusted within this range.

A display area 102 that shows the level of character recognition is provided, which displays “51%” in this example. There are provided an up button 104 and a down button 106. The operator can set the level of character recognition displayed on display area 102 by operating these buttons to enhance or reduce the level.

When a document includes numerous handwritten characters and the like, for example, the level of character recognition can be reduced to make a threshold value of matching smaller, so that a character can readily be determined as a specific character. In this case, the character recognition is unlikely to fail owing to the smaller threshold value of matching.

When a document includes numerous typed characters and the like, on the other hand, the level of character recognition can be enhanced to make the threshold value of matching greater, so that character recognition with high accuracy can be performed. In this case, the character recognition is likely to fail due to the greater threshold value of matching.

In the present embodiment, therefore, the number of determinations or the like during the dirt determination process described above is adjusted in accordance with the level of character recognition. Specifically, storage unit 26 stores a table in which the level of character recognition corresponds to a prescribed number such that a prescribed number of error determinations or the like is increased with higher level of character recognition, and a prescribed number of dirt determinations or the like is reduced with lower level of character recognition.

Then, a prescribed number in accordance with the level of character recognition is set by reading the table stored in storage unit 26. With this process, a criterion (prescribed number) for determining presence or absence of line noise is adjusted in accordance with a ratio of failure of character recognition which varies with adjustment of the level of character recognition, thus preventing erroneous determination that there is line noise despite its absence, or that there is no line noise despite its presence. Therefore, presence or absence of line noise, namely, dirt, can be efficiently detected.

A method of causing a computer to perform control as described in the above flow or a program to be executed by a computer for implementing this method may be provided. Such a program may be recorded in a computer-readable recording medium such as a flexible disc, a CD-ROM (Compact Disk-Read Only Memory), a ROM (Read Only Memory), a RAM (Random Access Memory), and a memory card, to be attached to a computer, and may be provided as a program product. Alternatively, a program may be provided as recorded in a recording medium such as a hard disk contained in a computer. Alternatively, a program may be provided by downloading via a network.

A program may invoke a necessary module from among program modules provided as a part of the operation system (OS) of the computer at prescribed timing in prescribed sequences and cause the module to perform processing. Here, the program itself does not include the module above but processing is performed in cooperation with the OS. Such a program not including a module may also be encompassed in the program according to the present invention.

In addition, the program according to the present invention may be provided as incorporated as a part of another program. In this case as well, the program itself does not include the module included in another program but processing is performed in cooperation with another program. Such a program incorporated in another program may also be encompassed in the program according to the present invention.

A provided program product is installed in a program storage portion such as a hard disk and executed. It is noted that the program product includes a program itself and a recording medium recording a program.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image reading device comprising:
a transport unit for transporting a document;
a scanner for scanning image data of the document transported by said transport unit; and
a controller for controlling said image reading device,
said controller extracting a plurality of one-character areas included in said image data, recognizing character data of each of extracted said one-character areas, determining presence or absence of line noise based on a result of recognition of each of said one-character areas, and displaying presence of said line noise on an operation panel when it is determined that there is said line noise.

2. The image reading device according to claim 1, wherein
said controller determines that there is said line noise when it is determined that there are at least a prescribed number of successive one-character areas where recognition failed in a transport direction of the document transported by said transport unit.

3. The image reading device according to claim 1, wherein
said controller determines that there is said line noise when it is determined that there are at least a prescribed number of successive one-character areas having character data recognized as specific character data in a transport direction of the document transported by said transport unit.

4. The image reading device according to claim 1, wherein
said controller determines that there is said line noise when it is determined that there are at least a prescribed number of successive one-character areas where recognition failed or one-character areas having character data recognized as specific character data in a transport direction of the document transported by said transport unit.

5. The image reading device according to claim 4, wherein
said controller adjusts a recognition level of the character data of each of extracted said one-character areas in accordance with an instruction, and adjusts a value of said prescribed number in accordance with adjusted said recognition level of the character data.

6. The image reading device according to claim 1, wherein
said controller identifies and displays a position of said line noise in said image data on said operation panel.

7. A method of reading an image performed in an image reading device, comprising the steps of:
transporting a document;
scanning image data of the transported document;
extracting a plurality of one-character areas included in said image data;
recognizing character data of each of extracted said one-character areas;
determining presence or absence of line noise based on a result of recognition of each of said one-character areas; and
displaying presence of said line noise on an operation panel when it is determined that there is said line noise.

8. The method of reading an image according to claim 7, wherein
in said step of determining presence or absence of line noise, it is determined that there is said line noise when it is determined that there are at least a prescribed number of successive one-character areas where recognition failed in a transport direction of the transported document.

9. The method of reading an image according to claim 7, wherein
in said step of determining presence or absence of line noise, it is determined that there is said line noise when it is determined that there are at least a prescribed number of successive one-character areas having character data recognized as specific character data in a transport direction of the transported document.

10. The method of reading an image according to claim 7, wherein
in said step of determining presence or absence of line noise, it is determined that there is said line noise when it is determined that there are at least a prescribed number of successive one-character areas where recognition failed or one-character areas having character data recognized as specific character data in a transport direction of the transported document.

11. The method of reading an image according to claim 10, further comprising the steps of:
adjusting a recognition level of the character data of each of extracted said one-character areas in accordance with an instruction; and
adjusting a value of said prescribed number in accordance with adjusted said recognition level of the character data.

12. The method of reading an image according to claim 7, wherein
in said displaying step, a position of said line noise in said image data is identified and displayed on said operation panel.

13. A recording medium storing a control program to be executed by a computer of an image reading device, said control program causing the computer of said image reading device to perform a process comprising the steps of:
transporting a document;
scanning image data of the transported document;
extracting a plurality of one-character areas included in said image data;
recognizing character data of each of extracted said one-character areas;
determining presence or absence of line noise based on a result of recognition of each of said one-character areas; and
displaying presence of said line noise on an operation panel when it is determined that there is said line noise.

14. The recording medium according to claim 13, wherein
in said step of determining presence or absence of line noise, it is determined that there is said line noise when it is determined that there are at least a prescribed number of successive one-character areas where recognition failed in a transport direction of the transported document.

15. The recording medium according to claim 13, wherein
in said step of determining presence or absence of line noise, it is determined that there is said line noise when it is determined that there are at least a prescribed number of successive one-character areas having character data recognized as specific character data in a transport direction of the transported document.

16. The recording medium according to claim 13, wherein
in said step of determining presence or absence of line noise, it is determined that there is said line noise when it is determined that there are at least a prescribed number of successive one-character areas where recognition failed or one-character areas having character data recognized as specific character data in a transport direction of the transported document.

17. The recording medium according to claim 16, wherein
said control program causes the computer of said image reading device to perform a process further comprising the steps of:
adjusting a recognition level of the character data of each of extracted said one-character areas in accordance with an instruction; and
adjusting a value of said prescribed number in accordance with adjusted said recognition level of the character data.

18. The recording medium according to claim 13, wherein
in said displaying step, a position of said line noise in said image data is identified and displayed on said operation panel.
